(19) United States
(12) Patent Application Publication
(10) Pub. No.: US 2015/0013553 A1
(43) Pub. Date: Jan. 15, 2015

(54) WARMING CONTAINER HAVING HEATING MEMBER

(71) Applicant: Sung-Ik JUNG, (US)

(72) Inventor: Sung-Ik Jung, Seoul (KR)

(21) Appl. No.: 14/377,404

(22) PCT Filed: Jan. 30, 2013
(86) PCT No.: PCT/KR2013/000773

§ 371 Date: Aug. 7, 2014

(30) Foreign Application Priority Data
Feb. 7, 2012 (KR) 10-2012-0012396

(51) Int. Cl. A47J 36/24

(52) U.S. Cl. CPC A47J 36/2483
USPC 99/483

(57) ABSTRACT

Provided is a warming container having a heating member. The warming container having a heating member includes: a container including a first metal member that is thermally conductive and magnetic; and a heating member magnetically connected to the first metal member for transferring generated heat to the first metal member. Therefore, food can be maintained at an adequate temperature. Also, the container can be easily transported and stored.

### TECHNICAL FIELD

The present disclosure relates to a warming container having a heating member for allowing a temperature of food stored in the container to be maintained at a constant level.

### BACKGROUND ART

Generally, people take food and drinks when engaging in outdoor activities such as hiking, fishing, or the like, and in order to maintain the temperature of food and drinks, a vacuum flask is commonly used. However, the temperature of food and drinks within the vacuum flask usually decreases over time, causing difficulties in maintaining the temperature thereof at a desired level after an extended period of time.

In order to solve the above-described problem, research is currently being undertaken into heating devices able to heat cups, milk bottles, and the like. For example, ‘a device for maintaining a temperature of a container and a device for heating a container’ is disclosed in Korean Patent No. 1033848.

However, the device disclosed in the aforementioned patent document is merely a heating device able to heat a container and is not integral with the container itself. In addition, as a volume of the heating device may be greater than that of the container itself, it may be difficult to carry the heating device together with the container. Since the heating device and the container are stored and carried separately, they may easily be lost.

Meanwhile, chefs and restaurant staff serving food to customers commonly make efforts to maintain food at an appropriate temperature until customers finish eating the food. For example, after a stone-like material having a high level of specific heat is heated for a certain period of time, food such as steak may be placed thereon, whereby a temperature of the food may be maintained for an appropriate period of time.

However, it is necessary to wash the stone for the cleanliness thereof after every use. In addition, as such a material is relatively heavy or bulky, it may be difficult to carry or transport, and setting a desired temperature may be a difficult task.

### DISCLOSURE

### Technical Problem

An aspect of the present disclosure provides a warming container capable of maintaining food stored therein at an appropriate temperature, and facilitating the portability and storage of the container.

An aspect of the present disclosure also provides a warming container, the exterior of which is maintained.

### Technical Solution

According to an aspect of the present disclosure, a warming container having a heating member may include a container including a first metal member having thermal conductivity and magnetic properties; and the heating member attached to the first metal member using the magnetic properties and generating heat which is transferred to the first metal member.

The heating member may include a second metal member having thermal conductivity and magnetic properties; and a power supply unit supplying power to the second metal member to allow the second metal member to generate the heat.

The container may further include a support member having a predetermined space, and the heating member may be accommodated in the predetermined space.

The heating member may be disposed on a bottom surface of the container to support the container.

The first metal member may be inserted in, or attached to, a surface of the container.

The first metal member may be disposed in a portion of the container corresponding to a position of food stored in the container.

The first metal member or the second metal member may include a ferromagnetic material or a paramagnetic material.

### ADVANTAGEOUS EFFECTS

According to exemplary embodiments of the present disclosure, a metal member having thermal conductivity may be inserted in, or attached to, a surface of a container, and heat generated by a heating member may be transferred to the container through the metal member, whereby food stored in the container may be maintained at an appropriate temperature.

In addition, the heating member and the metal member may be formed of a magnetic material such as a permanent magnet, such that the container and the heating member are attached to each other, which may facilitate portability and storage thereof.

According to exemplary embodiments of the present disclosure, the heating member may be accommodated in a space inside a support member of the container, whereby the exterior appearance of the container itself may be maintained. In a case in which the support member in the container is short or no support member is provided, the heating member itself may serve as the support member of the container.

### DESCRIPTION OF DRAWINGS

FIG. 1 is a cross-sectional view of a warming container having a heating member according to a first exemplary embodiment of the present disclosure;

FIG. 2 is a cross-sectional view of a warming container having a heating member according to a second exemplary embodiment of the present disclosure;

FIG. 3 is a cross-sectional view of a warming container having a heating member according to a third exemplary embodiment of the present disclosure;

FIG. 4 is a cross-sectional view of a warming container having a heating member according to a fourth exemplary embodiment of the present disclosure; and

FIG. 5 is a cross-sectional view of a warming container having a heating member according to a fifth exemplary embodiment of the present disclosure.

### BEST MODE

Hereinafter, embodiments of the present disclosure will be described in detail with reference to the accompanying drawings. The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art. In the drawings, the shapes and dimensions of elements may be exaggerated for clarity, and the same reference numerals will be used throughout to designate the same or like elements.

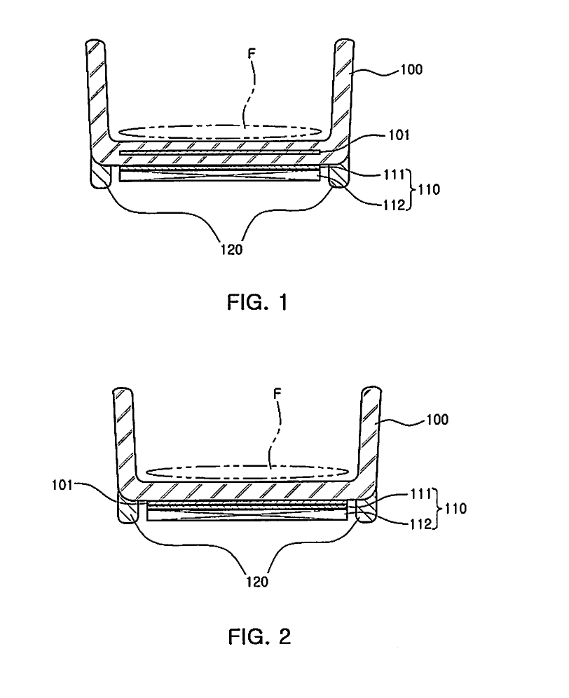

FIG. 1 is a cross-sectional view of a warming container having a heating member according to a first exemplary embodiment of the present disclosure, and FIG. 2 is a cross-sectional view of a warming container having a heating member according to a second exemplary embodiment of the present disclosure. FIGS. 1 and 2 illustrate a container 100 in which a support member 120 having a predetermined length is mounted or extended from a lower portion of the container 100.

With reference to FIGS. 1 and 2, the container 100 may include a food container capable of storing food F, such as a dish, a mug, a lock & lock container, a baby bottle, a water bottle, a lunch box or the like. A first metal member 101 may be installed in a bottom of the container 100, and the support member 120 may be installed on or extended from the bottom surface of the container 100 to support the container 100.

Here, the first metal member 101 may be detachable from a heating member 110 and may transfer heat generated by the heating member 110 to the container 100.

Specifically, the first metal member 101 may be a thin metal plate that may be inserted in the bottom of the container 100 (see FIG. 1) or may be attached to the bottom surface of the container 100 (see FIG. 2). The first metal member 101 may be installed in the entirety of the bottom surface of the container 100 or in a portion thereof corresponding to a position of the food F.

Meanwhile, the first metal member 101 may have magnetic properties and thermal conductivity. That is, the first metal member 101 may be formed of a ferromagnetic or paramagnetic material having magnetic properties, so that the first metal member 101 is detachable from the heating member 110 having magnetic properties. By forming the first metal member 101 using a magnetic material, the container 100 and the heating member 110 may be attached to each other, resulting in a technical effect of facilitating portability and storage.

Since the first metal member 101 may be formed of a metal having thermal conductivity, it may be attached to the heating member 110 to transfer heat generated by the heating member 110 to the container 100, resulting in a technical effect of maintaining a temperature of the food F at an appropriate level.

Meanwhile, the heating member 110 may include a second metal member 111 having thermal conductivity and magnetic properties, and a power supply unit 112 supplying power to the second metal member 111 to allow the second metal member 111 to generate heat.

The second metal member 111 of the heating member 110 and the first metal member 101 may be formed of a ferromagnetic or paramagnetic material having magnetic properties. The second metal member 111 may receive power from the power supply unit 112 to generate heat, and may transfer the heat to the first metal member 101 attached to the second metal member 111 using the magnetic properties.

According to another exemplary embodiment, the second metal member 111 may have a structure in which a permanent magnet having magnetic properties and a heat generator (metal) attached to the bottom of the permanent magnet and generating Joule's heat using the power supplied by the power supply unit 112 are stacked in a vertical direction. In such a structure, the permanent magnet may be attached to the first metal member 101 using the magnetic properties, and the Joule's heat generated by the heat generator may be transferred to the first metal member 101 through the permanent magnet.

In addition, the power supply unit 112 of the heating member 110 may include a secondary cell capable of charging and discharging electricity, and may supply the power to the second metal member 111 to allow the second metal member 111 to generate heat.

The heating member 110 may be installed on the bottom surface of the container 100 or may be accommodated in a predetermined space formed by the support member 120 extended from the bottom surface of the container 100. This configuration may allow the temperature of the food F to be maintained at an appropriate level, without spoiling the exterior appearance of the container 100 itself.

Although not shown in FIGS. 1 and 2, a switch may be further provided to open and close a connection between the power supply unit 112 and the second metal member 111, thereby controlling the temperature of the food F at a desired point in time.

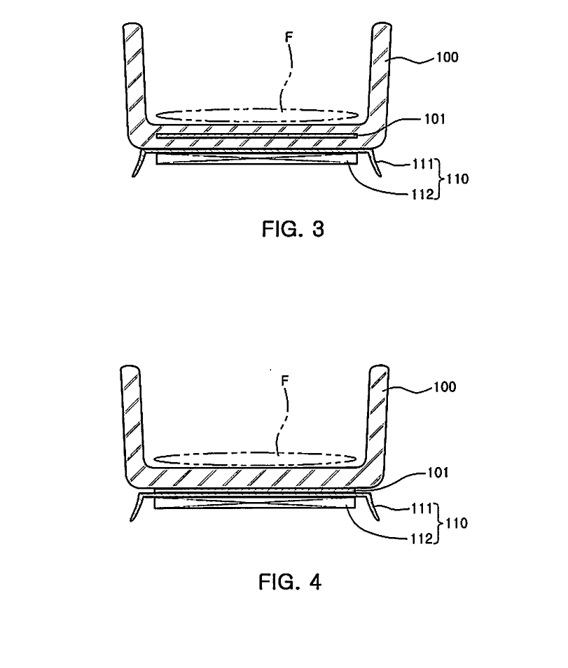

FIG. 3 is a cross-sectional view of a warming container having a heating member according to a third exemplary embodiment of the present disclosure, and FIG. 4 is a cross-sectional view of a warming container having a heating member according to a third exemplary embodiment of the present disclosure. In the exemplary embodiments of FIGS. 3 and 4, the container 100 does not include any support member. For convenience of explanation, descriptions will be provided based on a structure of the heating member 110 different from that illustrated in FIGS. 1 and 2.

As illustrated in FIGS. 3 and 4, the heating member 110 may include the second metal member 111 having thermal conductivity and magnetic properties, and the power supply unit 112 supplying power to the second metal member 111 to allow the second metal member 111 to generate heat.

Here, the second metal member 111 of the heating member 110 may serve as a support member supporting the container 100 below the container 100.

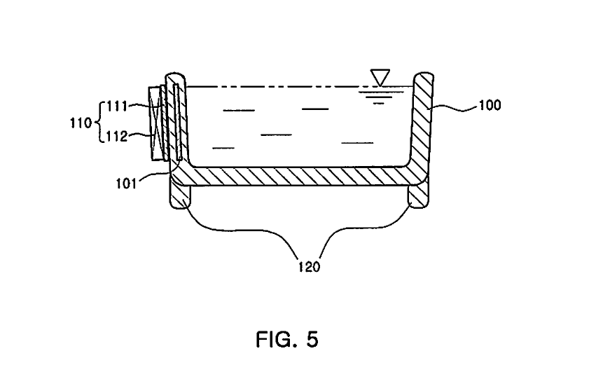

FIG. 5 is a cross-sectional view of a warming container having a heating member according to a fifth exemplary embodiment of the present disclosure. Unlike the embodiments of FIGS. 1 through 4, the first metal member 101 and the heating member 110 may be disposed on a side surface of the container 100.

Specifically, as illustrated in FIG. 5, the first metal member 101 may be inserted on the side of the container 100, and the heating member 110 may be installed on the side surface of the container 100 in which the first metal member 101 is inserted, thereby being attached to the first metal member 101.

Meanwhile, the first metal member 101 is illustrated as being inserted in the side of the container 100 in FIG. 5, but the first metal member 101 may be attached to the side surface of the container 100.

According to exemplary embodiments, the first metal member 101 may be inserted in the side of the container 100 in a circumferential direction or attached thereto.

Likewise, the heating member 110 may include the second metal member 111 and the power supply unit 112, and may allow the second metal member 111 to generate heat using the power supplied by the power supply unit 112. The heat generated by the second metal member 111 may be transferred to the container 100 through the first metal member 101 to maintain the temperature of the food F inside the container 100.

Hereinafter, the operational principles of a warming container having a heating member according to an exemplary embodiment of the present disclosure will be described in detail with reference to FIGS. 1 through 5.

The heating member 110 may be attached to the container 100, and such an attachment may be due to the magnetic properties of the second metal member 111 of the heating member 110 and the first metal member 101 inserted in the bottom of the container 100 as described above.

Then, when power is supplied to the second metal member 111 by the power supply unit 112 of the heating member 110, the second metal member 111 may generate heat using the supplied power.

The heat may be transferred to the first metal member 101 attached to the second metal member 111, and the transferred heat may be used to maintain the food F stored in the container 100 at a constant temperature. Here, the food F may be in a solid state such as steak as illustrated in FIGS. 1 through 4 or in a liquid state as illustrated in FIG. 5.

According to the present exemplary embodiment, a switch may be further provided to open and close a connection between the power supply unit 112 and the second metal member 111, thereby controlling the temperature of the food F at a desired point in time as described above.

According to the exemplary embodiment of the present disclosure, the metal member having thermal conductivity may be installed in or attached to the surface of the container 100 and the heat generated by the heating member 110 may be transferred to the container 100 through the metal member 101, whereby the temperature of the food F stored in the container 100 may be maintained at an appropriate level.

In addition, the second metal member 111 of the heating member 110 and the first metal member 101 are formed of a magnetic material such as a permanent magnet, such that the container 100 and the heating member 110 are attached to each other, which may facilitate portability and storage.

According to another exemplary embodiment of the present disclosure, the heating member 110 may be accommodated in a space formed inside the support member 120 of the container 100, whereby the exterior appearance of the container 100 itself may be maintained. In a case in which the support member 120 of the container 100 is short or no support member is provided, the heating member 110 may serve as the support member.

While exemplary embodiments have been shown and described above, it will be apparent to those skilled in the art that modifications and variations could be made without departing from the spirit and scope of the present disclosure as defined by the appended claims.

1. A warming container having a heating member, the warming container comprising:
a container including a first metal member having thermal conductivity and magnetic properties; and
the heating member attached to the first metal member using the magnetic properties and generating heat which is transferred to the first metal member.

2. The warming container of claim 1, wherein the heating member comprises:
a second metal member having thermal conductivity and magnetic properties; and
a power supply unit supplying power to the second metal member to allow the second metal member to generate the heat.

3. The warming container of claim 1, wherein the container further includes a support member having a predetermined space, and
the heating member is accommodated in the predetermined space.

4. The warming container of claim 1, wherein the heating member is disposed on a bottom surface of the container to support the container.

5. The warming container of claim 1, wherein the first metal member is inserted in, or attached to, a surface of the container.

6. The warming container of claim 5, wherein the first metal member is disposed in a portion of the container corresponding to a position of food stored in the container.

7. The warming container of claim 2, wherein the first metal member or the second metal member includes a ferromagnetic material or a paramagnetic material.
